(19) United States
(12) Patent Application Publication
(10) Pub. No.: US 2018/0274490 A1
(43) Pub. Date: Sep. 27, 2018

(54) CANISTER, AND VEHICLE MOUNTING STRUCTURE FOR CANISTER

(71) Applicant: MAZDA MOTOR CORPORATION, Hiroshima (JP)

(72) Inventor: Takuya HONJO, Utsunomiya-shi, Tochigi (JP)

(73) Assignee: MAZDA MOTOR CORPORATION, Hiroshima (JP)

(21) Appl. No.: 15/763,531

(22) PCT Filed: Aug. 29, 2016
(86) PCT No.: PCT/JP2016/075242

§ 371 Date: Mar. 27, 2018

(30) Foreign Application Priority Data
Nov. 10, 2015 (JP) 2015-220667

(51) Int. Cl. F02M 25/08

(52) U.S. Cl. CPC F02M 25/089; F02D 41/004; F02M 25/0854; F02M 25/0872

(57) ABSTRACT

Disclosed herein is a canister (1) having a passage therein. One end of the passage is provided with a fuel vapor introduction port (11) and a purge port (12). The other end of the passage is provided with an open-to-air port (13). The passage includes a first chamber (21) and a second chamber (22) sequentially arranged from the one end of the passage. The first and second chambers house first and second adsorbents (51) and (61), respectively, which are capable of adsorbing and desorbing fuel vapor. The canister is configured such that, when mounted on a vehicle, a first passage, of the passage, corresponding to the first chamber is approximately horizontal, and that a second passage, of the passage, corresponding to the second chamber is approximately vertical, with one side of the second passage closer to the open-to-air port being located above the other side of the second passage.

### TECHNICAL FIELD

The present disclosure relates to a canister mounted on a vehicle, such as an automobile, to adsorb and desorb fuel vapor, and an on-vehicle structure of the canister.

### BACKGROUND ART

Patent Document 1 discloses a canister which adsorbs and desorbs fuel vapor. A passage which allows a fluid to pass through is formed in this canister. One end of this passage is provided with a fuel vapor introduction port for introducing fuel vapor from a fuel tank, and a purge port which allows the passage to communicate with an intake passage of an engine. The other end of the passage is provided with an open-to-air port which communicates with atmospheric air. The passage includes a first chamber and a second chamber sequentially arranged from the one end of the passage. The first chamber houses a first adsorbent capable of adsorbing and desorbing fuel vapor. The second chamber houses a second adsorbent capable of adsorbing and desorbing fuel vapor.

In many cases, such a canister is mounted on a vehicle such that the passage runs horizontally, as disclosed in Patent Document 2, due to layout limitations of onboard components.

### CITATION LIST

### Patent Document

Patent Document 1: Japanese Unexamined Patent Publication No. 2015-117603
Patent Document 2: Japanese Unexamined Patent Publication No. 2014-208518

### SUMMARY OF THE INVENTION

### Technical Problem

In general, canisters such as the canister disclosed in Patent Document 1 carries out a purge by, for example, utilizing negative pressure of the intake passage during the operation of the engine, to desorb fuel components adsorbed onto the adsorbents housed in the first and second chambers and introduce the desorbed fuel components into the intake passage.

During the purge, the fuel components adsorbed onto the adsorbents in the first and second chambers move toward the intake passage due to the negative pressure of the intake passage. For example, the fuel adsorbed onto the second adsorbent in the second chamber moves toward the first chamber. When the engine stops, and the purge stops, the negative pressure of the intake passage disappears. Thus, the fuel components which remain adsorbed on the adsorbents in the first and second chambers do not move toward the intake passage any more, but move downward within the adsorbents due to gravity.

While the purge is not carried out as mentioned above, balancing between the fuel component concentrations in the adsorbents in the first and second chambers occurs. For example, the fuel component remaining on the second adsorbent in the second chamber is urged to move toward the open-to-air port within the second adsorbent when the concentration of said fuel component reaches or exceeds a certain concentration. The fuel component which has reached to an end toward the open-to-air port within the second adsorbent may be released from the open-to-air port.

A technique of the present disclosure is intended to provide a canister capable of curbing such release of the fuel component into the atmospheric air, and an on-vehicle structure of the canister.

### Solution to the Problem

A technique disclosed herein is directed to a canister mounted on a vehicle to adsorb and desorb a fuel vapor. The canister disclosed herein has a passage therein which allows a fluid to pass therethrough. One end of the passage is provided with a fuel vapor introduction port for introducing fuel vapor from a fuel tank, and a purge port which connects the passage to an intake passage of an engine. The other end of the passage is provided with an open-to-air port which communicates with atmospheric air. The passage includes a first chamber and a second chamber sequentially arranged from the one end of the passage. The first chamber houses a first adsorbent capable of adsorbing and desorbing fuel vapor, and the second chamber houses a second adsorbent capable of adsorbing and desorbing fuel vapor. The canister is configured such that, when mounted on the vehicle, a first passage, of the passage, corresponding to the first chamber is approximately horizontal, and that a second passage, of the passage, corresponding to the second chamber is approximately vertical, with one side of the second passage closer to the open-to-air port being located above the other side of the second passage.

According to this configuration, the canister is configured such that when mounted on the vehicle, the second passage, of the passage, corresponding to the second chamber is approximately vertical, with one side of the second passage closer to the open-to-air port being located above the other side of the second passage. Thus, the fuel component remaining in the second adsorbent housed in the second chamber is urged to move toward the open-to-air port at slower speed due to gravity. Consequently, it takes long time for the fuel component to reach the end of the adsorbent closer to the open-to-air port after the stop of the engine. The release of the fuel component into the atmospheric air is therefore reduced.

In one preferred embodiment, the canister is configured such that, when mounted on the vehicle, an end of the second chamber closer to the first chamber is positioned higher than an end of the first chamber closer to the second chamber.

According to this configuration, the canister is configured such that, when mounted on the vehicle, an end of the second chamber closer to the first chamber is positioned higher than an end of the first chamber closer to the second chamber. Thus, even if the fuel component accumulated in a lower portion of the second chamber due to gravity is liquefied through breakthrough, the fuel component can be guided into, and adsorbed onto, the first adsorbent in the first chamber.

Preferably, in said canister, the second adsorbent is configured such that a portion closer to the open-to-air port in an extending direction of the second passage adsorbs more fuel vapor than a portion farther from the open-to-air port in the extending direction of the second passage.

According to this configuration, the second adsorbent is configured such that a portion closer to the open-to-air port in an extending direction of the second passage adsorbs more fuel vapor than a portion farther from the open-to-air port in the extending direction of the second passage. Thus, the closer the fuel component remaining in the second adsorbent is to the open-to-air port, the slower the speed becomes at which the fuel component remaining in the second adsorbent is urged to move toward the open-to-air port due to capillarity. Consequently, it is possible to further increase the time until the fuel component reaches the end of the second adsorbent closer to the open-to-air port after the stop of the engine. The release of the fuel component into the atmospheric air is therefore reduced more advantageously.

Preferably, in said canister, the second chamber houses the second adsorbent comprised of a plurality of second adsorbents, and the second adsorbents and spaces are alternately arranged in an extending direction of the passage.

According to this configuration, the second chamber houses a plurality of second adsorbents. In the second chamber, the second adsorbents and the spaces are alternately arranged in the extending direction of the passage. Therefore, the fuel component remaining in any one of the second adsorbents is less urged to move toward the next second adsorbent. That is, the fuel component remaining in the second adsorbent is less urged to move toward the open-to-air port. Consequently, it is possible to further increase the time until the fuel component reaches the end of the adsorbent closer to the open-to-air port after the stop of the engine. The release of the fuel component into the atmospheric air is therefore reduced more advantageously.

Preferably, said canister includes a first case which forms the first chamber, and a second case which forms the second chamber, and the first passage and the second passage are connected to each other with a hose.

According to this configuration, the canister includes a first case which forms the first chamber, and a second case which forms the second chamber, and the first passage and the second passage are connected to each other with a hose. This configuration allows the first and second cases to be positioned appropriately. Thus, the degree of freedom of the on-vehicle layout of the canister improves.

The technique disclosed herein is also directed to an on-vehicle structure of a canister having the first and second cases described above. According to the on-vehicle structure of the canister disclosed herein, the first case is positioned under a floor pan of the vehicle, and the second case is positioned in a space surrounded by a rear fender of the vehicle.

According to this configuration, the space under the floor pan of the vehicle is effectively used for positioning the first case, and the space surrounded by the rear fender of the vehicle is effectively used for positioning the second case.

Preferably, in said on-vehicle structure of the canister, the first case is positioned between the floor pan of the vehicle and a silencer provided under the floor pan.

According to this configuration, the first case is positioned between the floor pan of the vehicle and the silencer. Thus, the lower side of the first case is covered by the silencer, allowing the first case to be protected from damage caused by flying gravel, for example. In addition, the first case is positioned above the silencer, in which an exhaust gas with a relatively high temperature with respect to ambient air flows, so that the whole first case is warmed by the silencer. This configuration can improve the activation state of the first adsorbent in the first case, and help the first adsorbent to desorb the fuel vapor component satisfactorily.

### Advantages of the Invention

According to a technique disclosed herein, it is possible to provide a canister capable of curbing release of a fuel component into the atmospheric air, and an on-vehicle structure suitable for such a canister.

### BRIEF DESCRIPTION OF THE DRAWINGS

FIG. 1 illustrates a perspective view of the appearance of a canister according to a first embodiment.

FIG. 2 illustrates a bottom view of a vehicle on which the canister of the first embodiment is mounted.

FIG. 3 illustrates a side view of a rear portion of the vehicle on which the canister of the first embodiment is mounted.

FIG. 4 schematically illustrates a configuration of a fuel vapor processing system having the canister of the first embodiment.

FIG. 5 illustrates a cross-sectional view of a first canister of the canister of the first embodiment.

FIG. 6 illustrates a cross-sectional view of a second canister of the canister of the first embodiment.

FIG. 7 illustrates a cross-sectional view of a second canister of a canister of a third embodiment.

FIG. 8 illustrates a bottom view of a vehicle on which a canister of a fifth embodiment is mounted.

FIG. 9 illustrates a side view of a rear portion of a vehicle on which the canister of the fifth embodiment is mounted.

### DESCRIPTION OF EMBODIMENT

Exemplary embodiments will now be described with reference to the drawings.

### First Embodiment

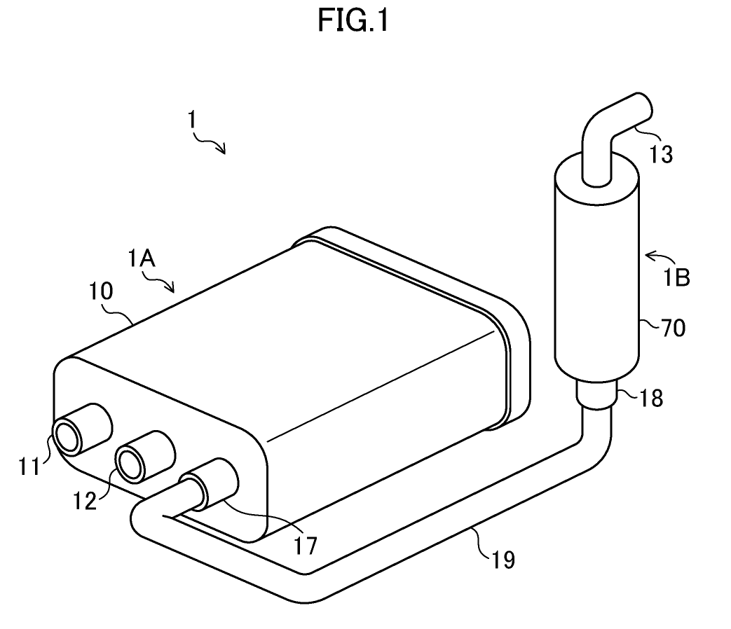

A canister 1 of a first embodiment will be described. FIG. 1 illustrates a perspective view of the appearance of the canister 1 according to the first embodiment. As illustrated in FIG. 1, the canister 1 includes a first canister 1A and a second canister 1B.

The first canister 1A has a case 10 as a first case. The case 10 is in a closed-end tubular shape. A bottom wall on one end of the case 10 in the axial direction of the tubular shape (hereinafter simply referred to as the “axial direction”) is provided with a fuel vapor introduction port 11, a purge port 12, and a connection port 17. The second canister 1B has a case 70 as a second case. The case 70 is in a closed-end tubular shape. A bottom wall on one end of the case 70 in the axial direction of the tubular shape (hereinafter simply referred to as the “axial direction”) is provided with an open-to-air port 13. A bottom wall on the other end of the case 70 in the axial direction of the tubular shape is provided with a connection port 18.

The connection port 17 of the first canister 1A and the connection port 18 of the second canister 1B are connected by a connection pipe 19. As will be described in detail later, a passage which allows a fluid to pass through is formed in the canister 1 (1A, 1B). One end of the passage is provided with the fuel vapor introduction port 11 and the purge port 12. The other end of the passage is provided with the open-to-air port 13 which communicates with the atmospheric air.

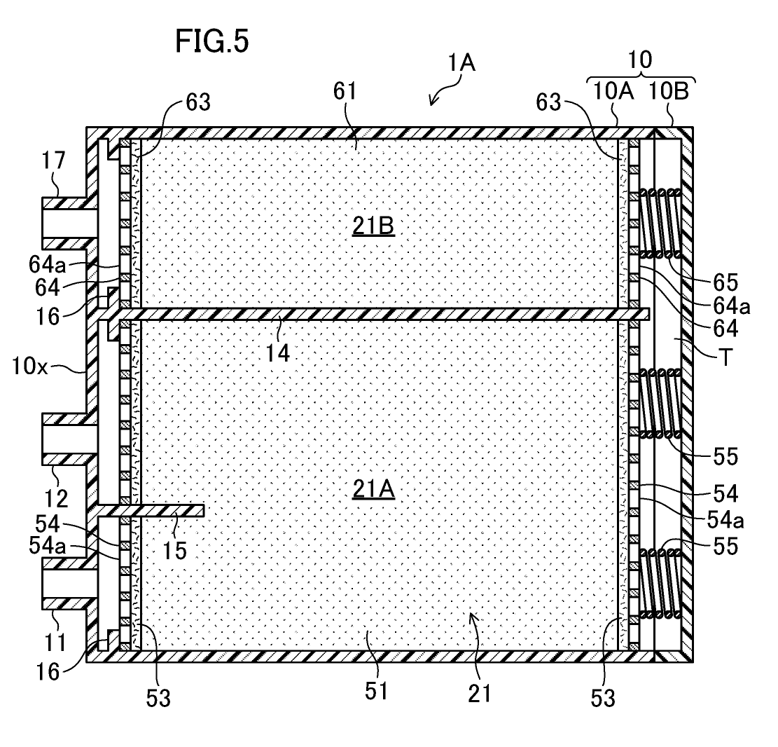

The passage further includes a first chamber (i.e., an interior space of the first canister 1A) 21 and a second chamber (i.e., an interior space of the second canister 1B) 22 sequentially arranged from the one end of the passage. The first chamber houses first adsorbents 51, 61 capable of adsorbing and desorbing fuel vapor, and the second chamber houses a second adsorbent 81 capable of adsorbing and desorbing fuel vapor (see FIGS. 5 an 6 which will be referred to later). In other words, the first and second chambers 21 and 22 form part (i.e., first and second passages) of the entire passage of the canister 1. The first passage of the first chamber 21 extends in a direction which approximately coincides with the axial direction of the tubular shape of the case 10 of the first canister 1A. The second passage of the second chamber 22 extends in a direction which approximately coincides with the axial direction of the tubular shape of the case 70 of the second canister 1B.

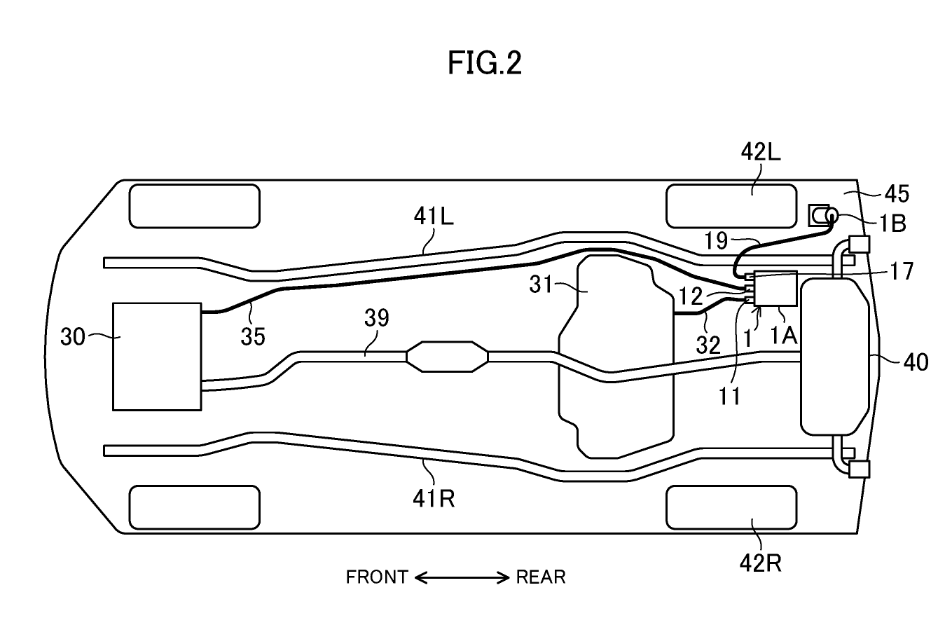

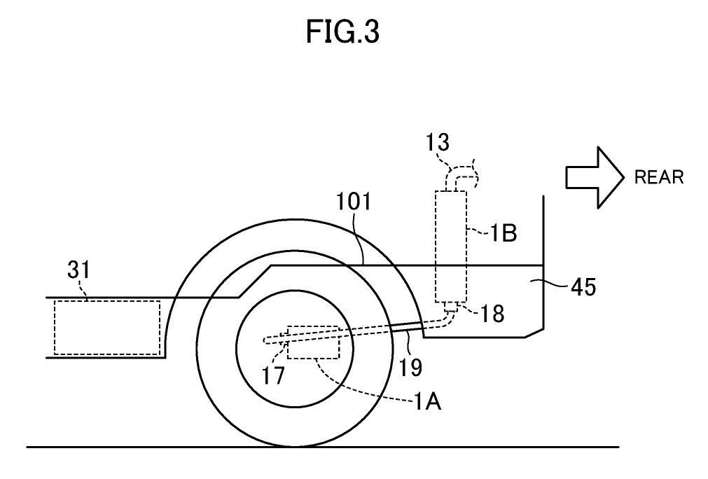

The canister 1 of the first embodiment is mounted on a vehicle such as an automobile. FIG. 2 illustrates a bottom view of a vehicle on which the canister 1 of the first embodiment is mounted. FIG. 3 illustrates a side view of a rear portion of the vehicle on which the canister 1 of the first embodiment is mounted. As illustrated in FIG. 2, a pair of left and right side frames 41L and 41R are arranged at side portions of the vehicle in its width direction, and extend from a front to rear portion of the vehicle. An engine 30 is mounted on the front portion of the vehicle between the side frames 41L and 41R. An exhaust pipe 39 extends from the engine 30 to a rear portion of the vehicle, and is connected to a silencer 40 provided under a floor pan 101. A fuel tank 31 is positioned on a lower surface of the floor pan 101 at a rear portion of the vehicle.

The first canister 1A is arranged at a position behind the fuel tank 31, near the front of the silencer 40, and closer to the inner side of the vehicle in the vehicle width direction with respect to the left side frame 41L. The canister 1 is arranged at the position near the front of the silencer 40 in order to keep the canister 1 warmed by the silencer 40, and reduce a temperature drop in the activated charcoal (i.e., latent heat of vaporization), thereby improving desorption properties of the canister 1. The first canister 1A is transversely mounted such that its axial direction is approximately horizontal. Further, as illustrated in FIG. 3, the first canister 1A is positioned at almost the same height as the fuel tank 31 by utilizing a space under the floor pan 101.

As illustrated in FIGS. 2 and 3, the second canister 1B is located opposite to the first canister 1A with respect to the left side frame 41L, and in a space surrounded by a rear fender 45 behind the left rear wheel 42L. The second canister 1B arranged at this position can be protected, by the left side frame 41L, from coming into contact with the exhaust pipe 39 in the event of side impact, for example. The connection ports 17 and 18 of the first and second canisters 1A and 1B are connected by a connection pipe 19. For example, for bending purpose, flexible materials such as a hose can be used as the connection pipe 19.

A purge passage 35 connecting (an intake passage 34 of) the engine 30 and the purge port 12 of the canister 1 extends along the left side frame 41L in the longitudinal direction of the vehicle. A fuel vapor introduction passage 32 connecting the fuel tank 31 and the fuel vapor introduction port 11 of the canister 1 extends in the longitudinal direction of the vehicle between the fuel tank 31 and the port 11. An open-to-air pipe (not shown) connected to the open-to-air port 13 of the canister 1 extends into the space surrounded by the rear fender 45 behind the left rear wheel 42L of the left and right rear wheels 42L and 42R.

As illustrated in FIG. 1, the second canister 1B is vertically mounted such that its axial direction is approximately vertical, and that its one side closer to the open-to-air port 13 is located above the other side. In the present embodiment, the “approximately vertical” position includes positions tilting 0- to 45-degree angles with respect to the vertically-oriented position.

Further, the second canister 1B is configured such that, when mounted on the vehicle, an end of the second chamber 22 closer to the first chamber 21 is positioned higher than an end of the first chamber 21 closer to the second chamber 22. The second chamber 1B is mounted in this manner to prevent the fuel component, accumulated in a lower portion of the second chamber 22 due to gravity, from being accumulated in, e.g., the connection pipe 19 even if the fuel component is liquefied through breakthrough, and to allow the fuel component to be guided into and adsorbed onto, the first adsorbents 51, 61 in the first chamber 21.

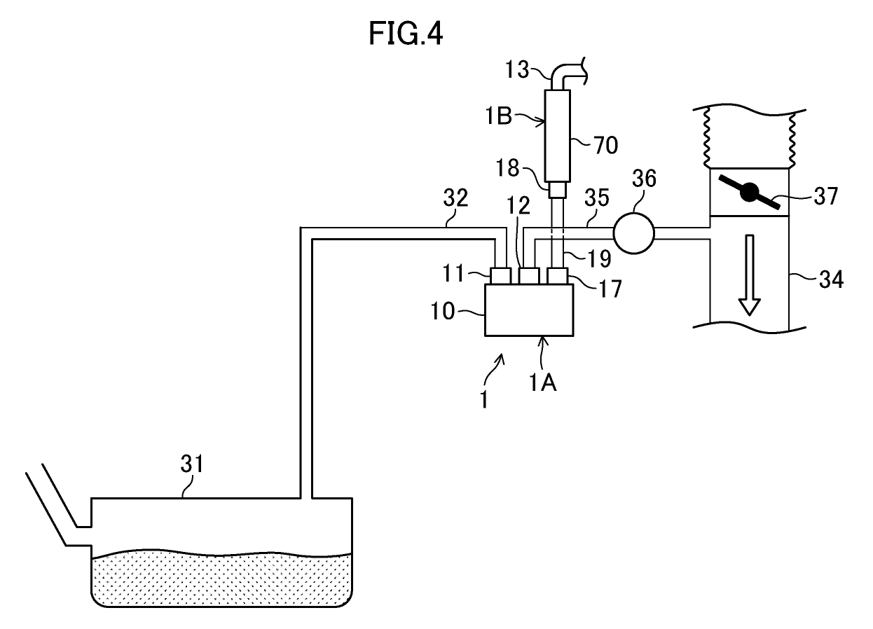

FIG. 4 schematically illustrates a configuration of a fuel vapor processing system having the canister 1 of the first embodiment. The fuel vapor processing system processes the fuel vapor generated in the fuel tank 31. The fuel vapor gas containing the fuel vapor generated in the fuel tank 31 is introduced into the canister 1 (1A, 1B) via the fuel vapor introduction passage 32 and the fuel vapor introduction port 11. The introduced fuel vapor is adsorbed onto the adsorbents (i.e., the first adsorbents 51, 61 and the second adsorbent 81) in the canister 1 (1A, 1B).

The purge port 12 is connected to the intake passage 34 of the engine 30 via the purge passage 35. When the intake passage 34 has negative pressure due to open/close operations of a throttle valve 37 during the operation of the engine 30, air is introduced into the canister 1 via the open-to-air port 13, allowing the adsorbents (i.e., the first adsorbents 51, 61 and the second adsorbent 81) to desorb the fuel component adsorbed thereon. The desorbed fuel component is introduced into the combustion chamber of the engine 30 from the purge passage 35 by way of the intake passage 34, and is used as a fuel for combustion.

A purge valve 36 is provided at the purge passage 35. A degree of opening of the purge valve 36 is controlled to adjust the amount of the fuel vapor to be introduced into the intake passage 34 by purge. The degree of opening of the purge valve 36 is controlled by an engine controller (ECU), not shown, based on the state of operation of the engine 30, for example.

FIG. 5 illustrates a cross-sectional view of the first canister 1A of the canister 1 according to the first embodiment. As illustrated in FIG. 5, the first canister 1A has the case 10. The case 10 includes a case body 10A in a closed-end tubular shape, and a lid 10B which closes an open end of the case body 10A. The case 10 is made of resin, for example. The case 10 is mounted on the vehicle such that the lid 10B is directed to the rear and a bottom plate 10x is directed to the front, that is, the axial direction of the case 10 coincides with the longitudinal direction of the vehicle.

The bottom plate 10x of the case body 10A of the case 10 is provided, on its outer surface, with the fuel vapor introduction port 11, the connection port 17, and the purge port 12. The connection port 17 is connected to the connection port 18 of the second canister 1B via the connection pipe 19 mentioned above.

The case 10 includes the first chamber 21 which houses the first adsorbents 51, 61. The bottom plate 10x of the case body 10A is provided, on its inner surface, with first and second partition walls 14 and 15, which project toward the open end of the case body 10A (that is, toward the lid 10B) in the axial direction of the case body 10A in the space within the case body 10A. The first chamber 21 is divided by the first and second partition walls 14 and 15.

The first partition wall 14 has a distal end located near the lid 10B, and divides the first chamber 21 into a chamber 21A which communicates with the purge port 12 and the fuel vapor introduction port 11, and a chamber 21B which communicates with the connection port 17. The projection amount of the second partition wall 15 is smaller than the projection amount of the first partition wall 14. The second partition wall 15 divides a space on one end of the first chamber 21 in the axial direction into two spaces: a space toward the fuel vapor introduction port 11 and a space toward the purge port 12.

The chamber 21A houses an air-permeable plate 54, a filter plate 53, the first adsorbent 51, another filter plate 53, and another air-permeable plate 54, which are arranged sequentially from the bottom plate 10x of the case body 10A. The wall of the case body 10A and the first partition wall 14 are provided with a stopper 16 projecting toward the inner side of the chamber 21A at a position near the bottom plate 10x of the case body 10A. A spring 55 is interposed between the lid 10B of the case 10 and the air-permeable plate 54 toward the lid 10B.

The spring 55 pushes the air-permeable plate 54, the filter plate 53, the first adsorbent 51, the filter plate 53, and the air-permeable plate 54 toward the stopper 16. Thus, each of the air-permeable plates 54, the filter plates 53, and the first adsorbent 51 is pushed against the adjacent one of these members, which contributes to preventing a gap from being formed between these members and between the first adsorbent 51 and the case 10. This configuration can facilitate the formation of the above-described structure by simply inserting said members into the chamber 21A in the stated order from the open end of case body 10A.

The chamber 21B houses an air-permeable plate 64, a filter plate 63, the first adsorbent 61, another filter plate 63, and another air-permeable plate 64, which are arranged sequentially from the bottom plate 10x of the case body 10A. The wall of the case body 10A and the first partition wall 14 are provided with a stopper 16 projecting toward the inner side of the chamber 21B at a position near the bottom plate 10x of the case body 10A. A spring 65 is interposed between the air-permeable plate 64 and the lid 10B of the case 10.

The spring 65 pushes the air-permeable plate 64 toward the stopper 16. Thus, each of the air-permeable plates 64, the filter plates 63, and the first adsorbent 61 is pushed against the adjacent one of these members, which contributes to preventing a gap from being formed between these members and between the first adsorbent 61 and the case 10. This configuration can facilitate the formation of the above-described structure by simply inserting said members into the chamber 21B in the stated order from the open end of case body 10A.

As described earlier, the first adsorbents 51 and 61 in the chambers 21A and 21B adsorb and desorb the fuel vapor generated in the fuel tank 31. Examples of the first adsorbents 51 and 61 include activated charcoal which can adsorb and desorb the fuel vapor. Examples of the activated charcoal for use as the first adsorbents 51 and 61 include those in the form of pellets with a diameter of about 2 mm and an axial length of about 4 mm, and having a pore size volumetric distribution with a peak at a pore size of about 5 nm.

The filter plates 53 and 63 provided in the chambers 21A and 21B are made of nonwoven fabric, for example. The filter plates 53 and 63 reduce the entrance of the activated charcoal finely powdered due to vibration, for example, into the passages through the ports. The air-permeable plates 54 and 64 provided in the chambers 21A and 21B are, for example, a grid plate having a large number of through holes 64a. The air-permeable plates 54 and 64 are made of resin, for example.

At the end of the case 10 closer to the lid 10B, there are a space, where the springs 55 and 65 are respectively interposed, between the air-permeable plate 54 of the chamber 21A and the lid 10B and between the air-permeable plate 64 of the chamber 21B and the lid 10B, and a gap between the end of the first partition wall 14 closer to the lid 10B and the lid 10B. These space and gap form a communicating portion T through which the chambers 21A and 21B communicate with each other.

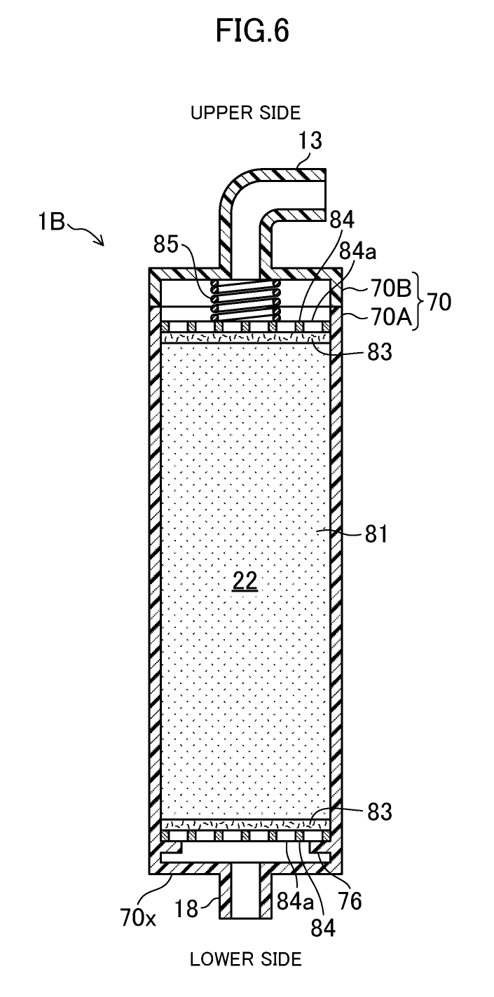

FIG. 6 illustrates a cross-sectional view of the second canister 1B of the canister 1 according to the first embodiment. As illustrated in FIG. 6, the second canister 1B has the case 70. The case 70 includes a case body 70A in a closed-end tubular shape, and a lid 70B which closes an open end of the case body 70A. The case 70 is made of resin, for example. The case 70 is mounted on the vehicle such that the lid 70B is directed upward and a bottom plate 70x is directed downward, that is, the axial direction of the case 70 coincides with the vertical direction of the vehicle.

The lid 70B (i.e., an upper end wall of the case 70) is provided with the open-to-air port 13. The bottom plate 70x of the case body 70A (i.e., a lower end wall of the case 70) is provided with the connection port 18 which communicates with the connection port 17 of the first canister 1A via the connection pipe 19. The case 70 includes the second chamber 22 which houses the second adsorbent 61.

The second chamber 22 houses an air-permeable plate 84, a filter plate 83, the second adsorbent 81, another filter plate 83, and another air-permeable plate 84, which are arranged sequentially from the bottom plate 70x of the case body 70A. The wall of the case body 70A is provided with a stopper 76 projecting toward the inner side of the second chamber 22 at a position near the bottom plate 70x of the case body 70A. A spring 85 is interposed between the air-permeable plate 84 and the lid 70B of the case 70.

The spring 85 pushes the air-permeable plate 84, the filter plate 83, the second adsorbent 81, the filter plate 83, and the air-permeable plate 84 toward the stopper 76. Thus, each of the air-permeable plates 84, the filter plates 83, and the second adsorbent 81 is pushed against the adjacent one of these members, which contributes to preventing a gap from being formed between these members and between the second adsorbent 81 and the case 70. This configuration can facilitate the formation of the above-described structure by simply inserting said members into the second chamber 22 in the stated order from the open end of case body 70A.

The second adsorbent 81 adsorbs and desorbs the fuel vapor generated in the fuel tank 31. Examples of the second adsorbent 81 include activated charcoal which can adsorb and desorb the fuel vapor. More specifically, activated charcoal having lower adsorption capability and higher desorption properties than the first adsorbent 51 in the first canister 1A is used as the second adsorbent 81. Such activated charcoal is used as the second adsorbent 81 because the second adsorbent 81 is required to adsorb the fuel, but at the same time, to be capable of easily desorbing the adsorbed fuel component during a purge, whereas the first adsorbent 51 is required to adsorb as much fuel as possible, and keep as much adsorbed fuel as possible from moving toward the second chamber 22.

Examples of the activated charcoal for use as the second adsorbent 81 include those in the form of pellets or of a monolithic type with a greater particle size than the material for the first adsorbent 51, 61, and having a pore size volumetric distribution with a peak at a pore size of about 1000 nm.

The filter plates 83 are made of nonwoven fabric, for example. The filter plates 83 reduce the entrance of the activated charcoal finely powdered due to vibration, for example, into the passages through the ports. The air-permeable plates 84 are, for example, a grid plate having a large number of through holes 84a. The air-permeable plates 84 are made of resin, for example.

Now, effects of the canister 1 of the first embodiment will be described. For example, during refueling or parking of a vehicle, a fuel vapor gas containing fuel vapor, which is a vaporized fuel generated in the fuel tank 31, is introduced into the canister 1 via the fuel vapor introduction port 11 due to an increase in the internal pressure of the fuel tank 31. The fuel component is adsorbed by the activated charcoal in the first chamber 21 (the first canister 1A) and the second chamber 22 (the second canister 1B). The gas from which the fuel component is almost completely removed is released into the atmospheric air from the open-to-air port 13.

In a case where the fuel vapor gas continues to be adsorbed onto the first adsorbent 51, and the concentration of the fuel component in the first adsorbent 51 reaches and exceeds a certain level, the fuel vapor gas moves into the communicating portion T. When the concentration of the fuel component in the communicating portion T reaches and exceeds a certain level, the fuel vapor gas is adsorbed onto the second adsorbent 61 in the second chamber 22 from a portion farther from the open-to-air port 13. When the concentration of the fuel component at the end of the second adsorbent 61 closer to the open-to-air port 13 reaches and exceeds a certain value, the fuel vapor gas may be released into the atmospheric air via the open-to-air port 13. When the engine 30 is actuated and a purge is carried out, the fuel component is gradually desorbed from the second adsorbent 61 on the side closer to the open-to-air port 13.

Specifically, when, for example, the engine 30 is actuated and the purge valve 36 is controlled to be open by the ECU (not shown) or is opened by a pressure difference, the atmospheric air is introduced into the second and first chambers 22 and 21 of the canister 1 via the open-to-air port 13 due to the negative pressure of the intake air of the engine 30. At this moment, the fuel vapor is desorbed (i.e., purged) from the first adsorbents 51 and 61 in the fuel chamber 21 and the second adsorbent 81 in the second chamber 22, and is fed to the intake passage 34 of the engine 30 via the purge port 12 together with the air.

In the first embodiment, the canister 1 is configured such that, when mounted on the vehicle, the second passage corresponding to the second chamber 22 is approximately vertical, and that one side of the second passage closer to the open-to-air port 13 is located above the other side thereof. Thus, the fuel component remaining on the second adsorbent 61 in the second chamber 22 is urged to move toward the open-to-air port 13 at lower speed due to gravity. Consequently, it takes long time for the fuel component to reach the end of the second adsorbent 61 closer to the open-to-air port 13 after the stop of the engine 30. The release of the fuel component into the atmospheric air is therefore reduced.

Further, in the first embodiment, the canister 1 is configured such that, when mounted on the vehicle, the end of the second chamber 22 closer to the first chamber 21 is positioned higher than the end of the first chamber 21 closer to the second chamber 22. Thus, even if the fuel component accumulated in a lower portion of the second chamber 22 due to gravity is liquefied through breakthrough, the fuel component is guided into, and adsorbed onto, the first adsorbent 51 in the first chamber 21.

Further, in the first embodiment, the canister 1 has the case 10 of the first canister 1A which forms the first chamber 21, and the case 70 of the second canister 1B which forms the second chamber 22. The first passage and the second passage are connected to each other with the connection pipe 19. This configuration allows the case 10 of the first canister 1A and the case 70 of the second canister 1B to be appropriately positioned. Thus, the degree of freedom of the on-vehicle layout of the canister 1 improves.

Further, in the first embodiment, the space under the floor pan 101 of the vehicle is effectively used for positioning the case 10 of the first canister 1A. The space surrounded by the rear fender 45 of the vehicle is effectively used for positioning the case 70 of the second canister 1B.

### Second Embodiment

A canister 1 of a second embodiment will be described with reference to the same drawings as used in the first embodiment. In the second embodiment, the second adsorbent 61 is configured such that a portion closer to the open-to-air port 13 in the axial direction of the case 70 (i.e., in the extending direction of the passage) adsorbs more fuel vapor than a portion farther from the open-to-air port 13. The other configurations of the canister 1 of the second embodiment are the same as, or similar to, those of the canister 1 of the first embodiment.

Thus, the closer the fuel component remaining in the second adsorbent 61 is to the open-to-air port 13, the slower the speed becomes at which the fuel component remaining in the second adsorbent 61 is urged to move toward the open-to-air port 13 due to capillarity. Consequently, it is possible to further increase the time until the fuel component reaches the end of the second adsorbent 61 closer to the open-to-air port 13 after the stop of the engine 30. The release of the fuel component into the atmospheric air is therefore reduced more advantageously.

### Third Embodiment

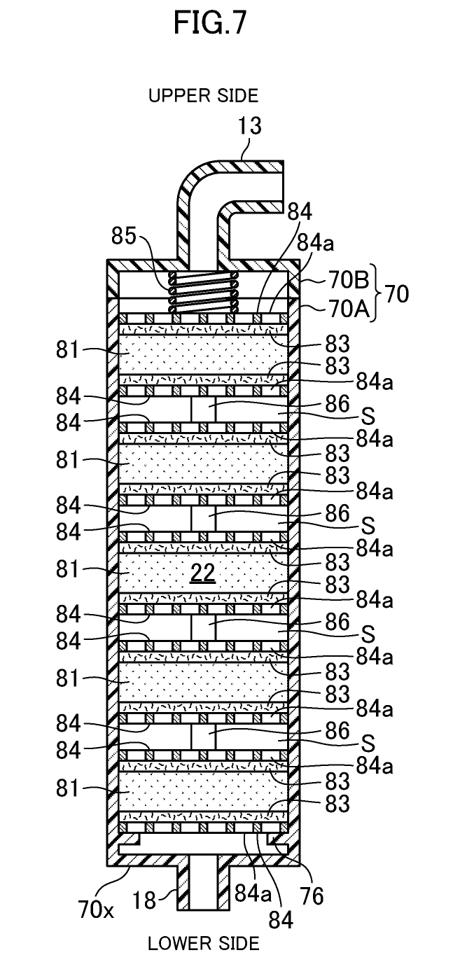

A canister 1 of a third embodiment will be described. FIG. 7 illustrates a cross-sectional view of a second canister 1B of the canister 1 of the third embodiment. As illustrated in FIG. 7, according to the second canister 1B of the third embodiment, the second chamber 22 houses a plurality of second adsorbents 81. In the second chamber 22, the second adsorbents 81 and spaces S are alternately arranged in the axial direction of the case 70 (i.e., in the extending direction of the passage).

Specifically, the second chamber 22 houses an air-permeable plate 84, a filter plate 83, a second adsorbent 81, a filter plate 83, an air-permeable plate 84, a space formation member 86, an air-permeable plate 84, a filter plate 83, a second adsorbent 81, a filter plate 83, an air-permeable plate 84, a space formation member 86, an air-permeable plate 84, a filter plate 83, a second adsorbent 81, a filter plate 83, an air-permeable plate 84, a space formation member 86, an air-permeable plate 84, a filter plate 83, a second adsorbent 81, a filter plate 83, an air-permeable plate 84, a space formation member 86, an air-permeable plate 84, a filter plate 83, a second adsorbent 81, a filter plate 83, and an air-permeable plate 84, which are sequentially arranged from a side closer to the bottom plate 70x of the case body 70A (i.e., a side farther from the open-to-air port 13).

The second adsorbent 81 adsorbs and desorbs the fuel vapor generated in the fuel tank 31. The second adsorbents 81 of the third embodiment have different lengths in the axial direction of the case 70 from the second adsorbent 81 of the first embodiment, but may have similar compositions to the compositions of the second adsorbent 81 of the first embodiment. For example, activated charcoal capable of adsorbing and desorbing fuel vapor can be used. The same air-permeable plates 84 and the same filter plates 83 as those used in the first embodiment may be used.

The space formation member 86 intervenes between two adjacent air-permeable plates 84 to form the space S between these air-permeable plates 84. The space formation members 86 and the air-permeable plates 84 are made of resin, for example. The space formation member 86 may be integrally formed, or bonded with an adhesive agent or other means, with the air-permeable plate 84 adjacent to the space formation member 86.

In this manner, the second chamber 22 includes a plurality of combinations (five combinations in this example) of the second adsorbent 81 with the filter plate 83 and the air-permeable plate 84, which sandwich the second adsorbent 81 from both sides. The combinations are arranged in series in the axial direction of the case 70. The space S is formed between adjacent ones of the combinations of the second adsorbent 81, the filter plate 83, and the air-permeable plate 84.

The wall of the case body 70A is provided with a stopper 76 projecting toward the inner side of the second chamber 22 at a position near the bottom plate 70x of the case body 70A. A spring 85 is interposed between the air-permeable plate 84 and the lid 70B of the case 70.

The spring 85 pushes the air-permeable plate 84 toward the stopper 76. Thus, each of the air-permeable plates 84, the filter plates 83, the second adsorbents 81, and the space formation members 86 is pushed against the adjacent one of these members, which contributes to preventing a gap from being formed between these members. This configuration can facilitate the formation of the above-described structure by simply inserting said members into the second chamber 22 in the stated order from the open end of case body 70A.

The other configurations of the canister 1 of the third embodiment are the same as, or similar to, those of the canister 1 of the first embodiment.

According to the third embodiment, the second chamber 22 houses a plurality of second adsorbents 61. In the second chamber 22, the second adsorbents 61 and the spaces S are alternately arranged in the extending direction of the passage. Therefore, the fuel component remaining in any one of the second adsorbents 61 is less urged to move toward the next second adsorbent 61. That is, the fuel component remaining in the second adsorbent 61 is less urged to move toward the open-to-air port 13. Consequently, it takes longer time for the fuel component to reach the end of the second adsorbent 61 closer to the open-to-air port 13 after the stop of the engine 30. The release of the fuel component into the atmospheric air is therefore reduced more advantageously.

### Fourth Embodiment

A canister 1 of a fourth embodiment will be described with reference to the same drawings as used in the third embodiment. In the fourth embodiment, a plurality of second adsorbents 81 are configured such that a second adsorbent 81 closer to the open-to-air port 13 in the extending direction of the passage adsorbs more fuel vapor than a second adsorbent 81 farther from the open-to-air port 13. In general, the fuel vapor adsorption capability is expressed by the butane working capacity (BWC). In this embodiment, the second adsorbents 81 are configured such that a second adsorbent 81 arranged closer to the open-to-air port 13 in the extending direction of the passage has a higher BWC value after a purge than a second adsorbent 81 farther from the open-to-air port 13.

Note that an adsorbent having a higher BWC value is an adsorbent having increased pore density per unit volume of the activated charcoal used as the adsorbent. For example, in forming the second adsorbents 81, a second adsorbent 81 arranged farther from the open-to-air port 13 may be made of collected pellets having a greater particle size than a second adsorbent 81 arranged closer to the open-to-air port 13.

The second adsorbents 81 closer to the open-to-air port 13 not only need to have higher adsorption capability, but also need to be capable of providing reliable desorption at the time of purge. Therefore, preferably, the adsorption capability is determined in consideration of a balance with the desorption properties at the time of purge. The other configurations of the canister 1 of the fourth embodiment are the same as, or similar to, those of the canister 1 of the first embodiment.

Thus, the closer the fuel component remaining in the second adsorbent 81 is to the open-to-air port 13, the slower the speed becomes at which the fuel component remaining in the second adsorbent 81 is urged to move toward the open-to-air port 13 due to capillarity. Consequently, it is possible to further increase the time until the fuel component reaches the open-to-air port 13 after the stop of the engine 30. The release of the fuel component into the atmospheric air is therefore reduced more advantageously.

### Fifth Embodiment

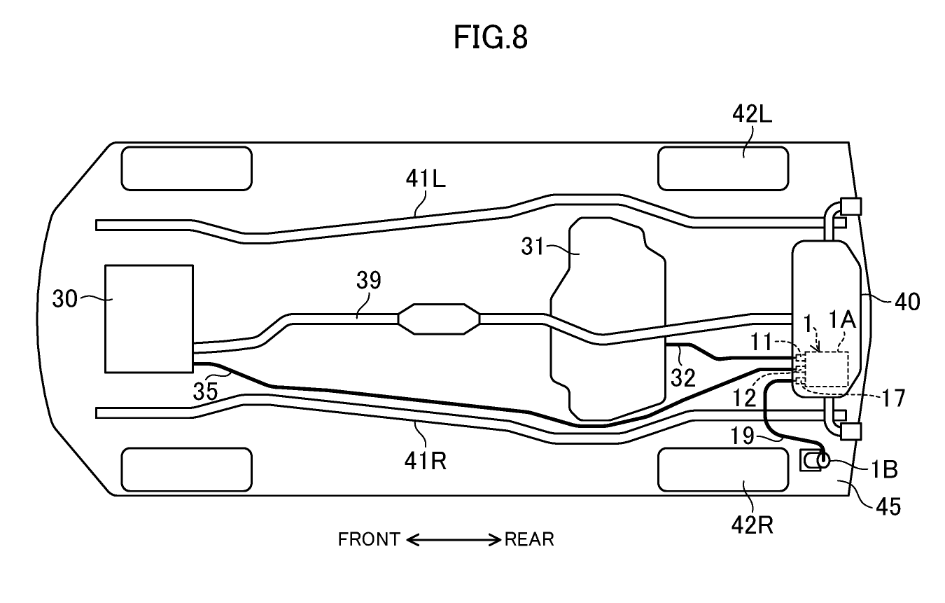

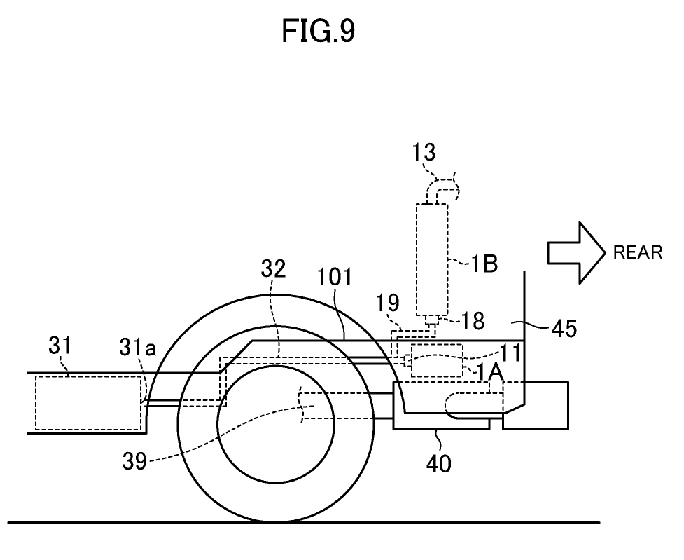

A canister 1 of a fifth embodiment will be described. FIG. 8 illustrates a bottom portion of a vehicle on which the canister 1 of the fifth embodiment is mounted. FIG. 9 illustrates a side view of a rear portion of the vehicle on which the canister 1 of the fifth embodiment is mounted. According to the fifth embodiment, as illustrated in FIGS. 8 and 9, the first canister 1A is positioned between the floor pan 101 of the vehicle and the silencer 40 provided under the floor pan 101.

Specifically, the first canister 1A is transversely mounted, with its axial direction extending approximately horizontally, at a position near an upper portion of the silencer 40. At the position, although the first canister 1A does not touch the silencer 40, heat from the silencer 40 reaches the first canister 1A. The first canister 1A is shielded from the ground by the silencer 40. The first canister 1A is arranged at the position near the upper portion of the silencer 40 in order to warm the whole first canister 40 by the heat of the silencer 40 in which a relatively high temperature exhaust gas flows.

As illustrated in FIG. 9, the first canister 1A is arranged at a higher position than the fuel tank 31. The fuel vapor introduction port 11 of the first canister 1A is positioned higher than a port 31a of the fuel tank 31. The fuel vapor introduction port 11 and the port 31a of the fuel tank 31 are connected via the fuel vapor introduction passage 32. Such a positional relationship between the fuel vapor introduction port 11 and the port 31a of the fuel tank 31 is effective in preventing liquid fuel in the fuel tank 31 (i.e., fuel not in the vapor state) from being introduced into the first canister 1A.

According to the fifth embodiment, the first canister 1A is positioned between the floor pan 101 of the vehicle and the silencer 40 positioned under the floor pan 101. Thus, the lower side of the first canister 1A is covered by the silencer 40, allowing the first canister 1A to be protected from damage caused by flying gravel, for example. In addition, the whole of the first canister 1A is warmed by the silencer 40 because the first canister 1A is positioned near the upper portion of the silencer 40. This configuration can improve the activation state of the first adsorbent 51 in the case 10, and help the first adsorbent 51 to desorb the fuel vapor component satisfactorily.

The canisters 1 of the above embodiments have the following configurations and characteristics.

The canister 1 according to each of the first to fifth embodiments is directed to a canister 1 mounted on a vehicle to adsorb and desorb a fuel vapor, wherein

a passage which allows a fluid to pass therethrough is formed inside the canister,

one end of the passage is provided with a fuel vapor introduction port 11 for introducing the fuel vapor from a fuel tank 31, and a purge port 12 which connects the passage to an intake passage 34 of an engine 30,

the other end of the passage is provided with an open-to-air port 13 which communicates with atmospheric air,

the passage includes a first chamber 21 and a second chamber 22 sequentially arranged from the one end of the passage, the first chamber 21 housing a first adsorbent 51, 61 capable of adsorbing and desorbing the fuel vapor, and the second chamber 22 housing a second adsorbent 81 capable of adsorbing and desorbing the fuel vapor, and

the canister is configured such that, when mounted on the vehicle,

a first passage, of the passage, corresponding to the first chamber 21 is approximately horizontal, and

a second passage, of the passage, corresponding to the second chamber 22 is approximately vertical, with one side of the second passage closer to the open-to-air port 13 being located above the other side of the second passage.

According to the first to fifth embodiments,

the canister is configured such that, when mounted on the vehicle, an end of the second chamber 22 closer to the first chamber 21 is positioned higher than an end of the first chamber 21 closer to the second chamber 22.

According to the second and fourth embodiments,

the second adsorbent 81 is configured such that a portion closer to the open-to-air port 13 in an extending direction of the second passage adsorbs more fuel vapor than a portion farther from the open-to-air port 13 in the extending direction of the second passage.

According to the third and fourth embodiments,

the second chamber 22 houses the second adsorbent 81 comprised of a plurality of second adsorbents 81, and

in the second chamber 22, the second adsorbents 81 and spaces S are alternately arranged in an extending direction of the passage.

According to the first to fifth embodiments,

the canister 1 includes a case 10 as a first case which forms the first chamber 21, and a case 70 as a second case which forms the second chamber 22, and

the first passage and the second passage are connected to each other with a connection pipe 19.

According to this configuration, the canister 1 includes the case 10 which forms the first chamber 21, and the case 70 which forms the second chamber 22, and the first passage and the second passage are connected to each other with the connection pipe 19. This configuration allows both of the cases 10 and 70 to be positioned appropriately. Thus, the degree of freedom of the on-vehicle layout of the canister 1 improves.

According to the first to fifth embodiments,

the case 10 which forms the first chamber 21 is positioned under a floor pan 101 of the vehicle, and

the case 70 which forms the second chamber 22 is positioned in a space surrounded by a rear fender 45 of the vehicle.

According to this configuration, the space under the floor pan 101 of the vehicle is effectively used for positioning the case 10 which forms the first chamber 21, and the space surrounded by the rear fender 45 of the vehicle is effectively used for positioning the case 70 which forms the second chamber 22.

According to the fifth embodiment,

the case 10 which forms the first chamber 21 is positioned between the floor pan 101 of the vehicle and a silencer 40 provided under the floor pan 101.

### Other Embodiments

As can be seen, preferred embodiments have just been described as examples of the technique of the present disclosure. However, the technique of the present disclosure is not limited to these embodiments, and is also applicable to those embodiments in which changes, replacement, addition, omission, and other modifications are made. Alternatively, components described in the above embodiments may be combined as another embodiment. In addition, some of the components illustrated in the appended drawings or mentioned in the detailed description may be unessential in solving the problem. Therefore, such unessential components should not be taken for essential ones, simply because such unessential components are illustrated in the drawings or mentioned in the detailed description.

For example, the foregoing embodiments may also have the following structures.

In the first to fifth embodiments, the first chamber 21 is formed in the first canister 1A, and the second chamber 22 is formed in the second canister 1B. That is, the first and second chambers 21 and 22 are formed in the different cases 10 and 70. However, the first and second chambers 21 and 22 may be integrally formed, for example, in one case 10, as long as the canister is configured as follows when mounted on the vehicle: the first passage, of the passage, corresponding to the first chamber 21 is approximately horizontal; and the second passage, of the passage, corresponding to the second chamber 22 is approximately vertical, with its one side closer to the open-to-air port 13 being located above the other side thereof.

In the first to fourth embodiments, the first canister 1A is positioned at almost the same height as the fuel tank 31. In such a case as well, similarly to the fifth embodiment, the fuel vapor introduction port 11 of the first canister 1A is preferably positioned higher than the port 31a of the fuel tank 31 (to which port 31a the fuel vapor introduction port 11 is connected via the fuel vapor introduction passage 32) in order to prevent liquid fuel in the fuel tank 31 from being introduced into the first canister 1A.

In the third and fourth embodiments, five combinations of the air-permeable plate 64, the second adsorbent 61, and the air-permeable plate 64 are provided. However, the number of combinations of these components may be four or less, or six or more.

### INDUSTRIAL APPLICABILITY

The canister disclosed herein may be widely used as a canister mounted on a vehicle, such as an automobile, to adsorb and desorb fuel vapor.

### DESCRIPTION OF REFERENCE CHARACTERS

1 Canister
1A First Canister
1B Second Canister
10 Case
10A Case Body
10B Lid
10x Bottom Plate
11 Fuel Vapor Introduction Port
12 Purge Port
13 Open-To-Air Port
14 Partition Wall
15 Partition Wall
16 Stopper
17 Connection Port
18 Connection Port
19 Connection Pipe
20 First Chamber
21A Chamber
21B Chamber
22 Second Chamber
30 Engine
31 Fuel Tank
32 Fuel Vapor Introduction Passage
34 Intake Passage
35 Purge Passage
36 Purge Valve
37 Throttle Valve
39 Exhaust Pipe
40 Silencer
41L Left Side Frame
41R Right Side Frame
42L Left Rear Wheel
42R Right Rear Wheel
45 Rear Fender
51 First Adsorbent
53 Filter Plate
54 Air-Permeable Plate
51a Through Hole
55 Spring
61 First Adsorbent
63 Filter Plate
64 Air-Permeable Plate
64a Through Hole
65 Spring
70 Case
70A Case Body
70B Lid
70x Bottom Plate
81 Second Adsorbent
83 Filter Plate
84 Air-Permeable Plate
84a Through Hole
85 Spring
86 Space Formation Member
S Space
T Communicating Portion

1. A canister mounted on a vehicle to adsorb and desorb a fuel vapor, wherein
a passage which allows a fluid to pass therethrough is formed inside the canister,
one end of the passage is provided with a fuel vapor introduction port for introducing the fuel vapor from a fuel tank, and a purge port which connects the passage to an intake passage of an engine,
the other end of the passage is provided with an open-to-air port 13 which communicates with atmospheric air,
the passage includes a first chamber and a second chamber sequentially arranged from the one end of the passage, the first chamber housing a first adsorbent capable of adsorbing and desorbing the fuel vapor, and the second chamber housing a second adsorbent capable of adsorbing and desorbing the fuel vapor, and
the canister is configured such that, when mounted on the vehicle,
a first passage, of the passage, corresponding to the first chamber is approximately horizontal, and
a second passage, of the passage, corresponding to the second chamber is approximately vertical, with one side of the second passage closer to the open-to-air port being located above the other side of the second passage.

2. The canister of claim 1, wherein
the canister is configured such that, when mounted on the vehicle, an end of the second chamber closer to the first chamber is positioned higher than an end of the first chamber closer to the second chamber.

3. The canister of claim 1, wherein
the second adsorbent is configured such that a portion closer to the open-to-air port in an extending direction of the second passage adsorbs more fuel vapor after a purge than a portion farther from the open-to-air port in the extending direction of the second passage.

4. The canister of claim 1, wherein
the second chamber houses the second adsorbent comprised of a plurality of second adsorbents, and
in the second chamber, the second adsorbents and spaces are alternately arranged in an extending direction of the passage.

5. The canister of claim 1, wherein
the canister includes a first case which forms the first chamber, and a second case which forms the second chamber, and
the first passage and the second passage are connected to each other with a hose.

6. An on-vehicle structure of the canister of claim 5, wherein
the first case is positioned under a floor pan of the vehicle, and
the second case is positioned in a space surrounded by a rear fender of the vehicle.

7. The on-vehicle structure of claim 6, wherein
the first case is positioned between the floor pan of the vehicle and a silencer provided under the floor pan.

8. The canister of claim 2, wherein
the second adsorbent is configured such that a portion closer to the open-to-air port in an extending direction of the second passage adsorbs more fuel vapor after a purge than a portion farther from the open-to-air port in the extending direction of the second passage.

9. The canister of claim 2, wherein
the second chamber houses the second adsorbent comprised of a plurality of second adsorbents, and
in the second chamber, the second adsorbents and spaces are alternately arranged in an extending direction of the passage.

10. The canister of claim 2, wherein
the canister includes a first case which forms the first chamber, and a second case which forms the second chamber, and
the first passage and the second passage are connected to each other with a hose.

11. The canister of claim 3, wherein
the canister includes a first case which forms the first chamber, and a second case which forms the second chamber, and
the first passage and the second passage are connected to each other with a hose.

12. The canister of claim 4, wherein
the canister includes a first case which forms the first chamber, and a second case which forms the second chamber, and
the first passage and the second passage are connected to each other with a hose.
